(19) United States
(12) Patent Application Publication
(10) Pub. No.: US 2026/0065077 A1
(43) Pub. Date: Mar. 5, 2026

(54) Secure Multiparty Protocol for Fine-tuning of Language Models

(71) Applicant: Oracle International Corporation, Redwood City, CA (US)

(72) Inventors: Wei Jiang, Nolensville, TN (US); Arisa Tajima, Amherst, MA (US); Virendra J. Marathe, Nashua, NH (US); Adam C. Pocock, Burlingon, MA (US)

(21) Appl. No.: 19/260,048

(22) Filed: Jul. 3, 2025

Related U.S. Application Data
(60) Provisional application No. 63/688,788, filed on Aug. 29, 2024.

(51) Int. Cl. G06N 3/0985; G06N 3/0475; H04L 9/40

(52) U.S. Cl. CPC G06N 3/0985; G06N 3/0475; H04L 63/04

(57) ABSTRACT

Systems and methods for implementing a secure multiparty protocol for fine-tuning of language models are disclosed. An end-to-end privacy-preserving protocol using secure multi-party computation (MPC) and executed on a plurality of computing nodes enables fine-tuning a language model targeting classification tasks using private, sensitive data while providing secure protection of the training data and without sacrificing model accuracy.

### PRIORITY CLAIM

This application claims benefit of priority to U.S. Provisional Application Ser. No. 63/688,788, titled “Secure Multiparty Protocol for Fine Tuning Language Models,” filed Aug. 29, 2024, and which is hereby incorporated herein by reference in its entirety.

### BACKGROUND

### Field of the Disclosure

This disclosure relates generally to computer hardware and software, and more particularly to systems and methods for implementing machine learning systems.

### Description of the Related Art

Privacy is often required for public release of large models trained on sensitive data. Traditional approaches to providing differential privacy in machine learning models involve adding noise to a classical network training process. This technique, however, may significantly degrade model accuracy, even when using the current state-of-the-art training algorithms and modest privacy guarantees.

### SUMMARY

Methods, techniques and systems for implementing a secure multiparty protocol for fine-tuning of language models are described herein. A plurality of computing systems including one or more processors and memory may implement an end-to-end privacy-preserving protocol using secure multi-party computation (MPC) to enable fine-tuning a language model targeting classification tasks using private, sensitive data while providing secure protection of the training data and without sacrificing model accuracy.

### BRIEF DESCRIPTION OF THE DRAWINGS

FIG. 1 is a block diagram illustrating a distributed system implementing a secure multiparty protocol for fine-tuning of language models, according to at least one embodiment.

FIG. 2 is a block diagram illustrating a framework for fine-tuning of encoder models using a secure multiparty protocol, according to at least one embodiment.

FIG. 3 is a flowchart illustrating creating of an encoder model using a secure multiparty protocol, according to at least one embodiment.

FIG. 4 is a flowchart illustrating aggregating secret training information for fine-tuning of an encoder model using a secure multiparty protocol, according to at least one embodiment.

FIG. 5 is a flowchart illustrating training of an encoder model using a secure multiparty protocol, according to at least one embodiment.

FIG. 6 is a flowchart illustrating an alternative activation function and dropout layer for training of an encoder model using a secure multiparty protocol, according to at least one embodiment.

FIG. 7 is a block diagram illustrating one embodiment of a computing system that is configured to implement enhanced ticket lock operations, as described herein.

FIG. 8 illustrates an example cloud computing environment whose resources may be employed to implement a topic modeling system that includes stability monitoring, according to at least some embodiments.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (i.e., meaning having the potential to) rather than the mandatory sense (i.e. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112 (f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

Fine-tuning language models is an essential technique for improving performance on downstream tasks. However, this process often involves sensitive training data raising significant privacy concerns, especially when data comes from a federation of data owners. For example, multiple healthcare organizations may want to fine-tune a language model, like BERT, for text classification or summarization tasks. Due to privacy concerns, the training data cannot be simply pulled together for fine-tuning. These challenges may be addressed using decentralized data from multiple clients while ensuring both data and model confidentiality. Using Secure Multiparty Computation (MPC), an efficient privacy-preserving fine-tuning framework is disclosed that is agnostic to any variants of encoder-only transformer models. Additionally, novel techniques may be used to reduce the runtime and network traffic of the secure protocol by introducing MPC-friendly designs, tailored to task-specific architectures, and devising architecture-driven optimizations. For instance, dropout masks may be used to reduce communication volumes for activation functions and matrix multiplication. Using MPC, accuracy of fine tuning may be preserved as if the model were fine-tuned on the original data.

Training a language model, especially ones with billions of parameters, requires a very large amount of computing resources that may be unattainable for many small or mid-size organizations. Fortunately, many pre-trained/base models are publicly available and organizations have the option of fine-tuning a base model using domain or application specific dataset for downstream tasks. Fine tuning often leads to more accurate models and requires significantly fewer computing resources. Since existing fine-tuning solutions assume the training data are directly accessible, they are not applicable when the data cannot be shared directly due to privacy, data confidentiality, laws and regulations, such as HIPAA, GDPR, etc. Some situations prohibit the use of current fine-tuning approaches.

An example is data and service outsourcing where organizations which lack of IT resources can outsource their data management and analytics tasks to a cloud. For highly sensitive data, it is in the organization's best interest to encrypt the data using their own keys without relying entirely on the cloud provider. However, when the data are encrypted using a customer's own key, the cloud will not be able to perform analytical tasks or train AI models on behalf of the customer which defeats the main purpose of data outsourcing.

Collaborative learning is another application where, due to lack of training data or data diversity, multiple organizations in a federation may want to combine their private data for fine-tuning a language model. For example, healthcare organizations at different regions may serve a particular group of patients, and specialists may only provide treatment for a limited range of syndromes or diseases. Thus, each organization alone has insufficient amount of fine-tuning data and it is not possible to pull their private data together.

Another example is when data residency and geographical restriction may prevent data from moving out of current jurisdiction. As a result, a global organization may not be able to aggregate data from its own subsidiaries to train or fine tune a language model. In order to fine tune a language model under the aforementioned circumstances, a privacy-preserving solution is needed. There are several well known general purpose privacy-enhancing technologies: Differential Privacy (DP), Federated Learning (FL), Fully Homomorphic Encryption (FHE) and Secure Multiparty Computation (MPC). Each technique has its pros and cons. For instance, MPC offers more secure protection on the training data without sacrificing model accuracy comparing to DP and FL based solution. It is also more efficient than FHE. On the other hand, MPC is computationally more expensive than DP and FL. To maximize privacy of the training data and accuracy of the fine-tuned model, MPC-based building blocks are used to develop a privacy-preserving fine-tuning protocol.

To define the problem, let P₁, . . . , Pₘ, represent m data owners/clients interested in fine-tuning a language model on their aggregate datasets D₁, . . . , Dₘ without disclosing each Pᵢ's private dataset Dᵢ to the other parties. To maximize efficiency, assume there are three designated MPC servers S₁, S₂ and S₃ responsible of performing the required secure computations on the secret shares [Dᵢ] of Dᵢ. Depending on the underlying MPC-based building blocks, a minimum of either two or three servers is needed to perform MPC computations when the original data are secretly shared. More servers are possible, but will greatly increase the no-time complexity. Let L be the base model of a language model and [symbol] be the fine-tuned model. An end-to-end privacy-preserving fine-tuning (PPFT) protocol may be formulated at follows:

$$PPFT ( < {P}_{t} , {D}_{i} , L > , ( {S}_{j} , ⊥ ) ) \to < {S}_{j} , {[ ℒ ]}_{j} >$$

Each Sⱼ does not have its own private input, and the protocol outputs the secret shares of [symbol] . More specifically, at the end of the protocol execution. each server stores secret shares of the fine-tuned model, denoted by [ [symbol] ]ⱼ. Note that depending on the actual requirement, each Pᵢ could also obtain the actual fine-tuned model [symbol] . Another option is keeping [symbol] secret from all parties involved, and the servers can perform model inference based on and secret shares of a user query. At the end, only the authorized user learns the inference result. This approach works for all these scenarios without changing the main structure of the PPFT protocol.

Peer-to-Peer Vs. Multi-Server Setting

MPC protocols may be collaboratively executed among the data owners P₁, . . . , Pₘ. However, when m>3, such an implementation becomes inefficient. In addition, Pᵢ may not have sufficient computing resources and expertise to support intensive MPC computations. Therefore, the multi-server setting where MPC computations are performed by three designated computing servers is a better choice from efficiency and data outsourcing perspectives. Data owners simply delegate almost all computations to S₁, S₂ and S₃. Although it is possible to utilize only two computing servers, this often requires either public-key or homomorphic encryption-based building blocks which lead to inefficient protocols for most applications.

### Threat Model

An MPC-based PPFT protocol may leverage general purpose MPC libraries such as MP-SPDZ, MPyC, ABY3 and so forth. These libraries are not designed for training deep learning models and do not direct work on GPUs. As a result, the CrypTen library may be used as this library is specifically developed for deep learning tasks. Nevertheless, it is not straightforward to use under a multi-server setting. CrypTen was originally designed for the peer-to-peer settings where each computing server has access to original training data, and conversion from PyTorch data processing libraries to CrypTen models using ONNX is not fully supported when implementing custom layers.

Although there are prior works that developed MPC-based solutions to train neural network models and transformer-based model inferences, no existing MPC solutions are directly applicable for end-to-end fine tuning of a language model. This approach provides additional functionalities for the CrypTen library to handle ONNX compatibility and enable function in a multi-server setting, provides end-to-end privacy-preserving fine tuning process without each data owner leaking its private dataset where the fine-tuned model remains hidden from all participating parties to maximize privacy, provides novel optimization techniques to improve run-time efficiency of the base protocol, and is general and applicable to other encoder-only transformer models and classification tasks.

Additive secret sharing is the fundamental MPC primitive adopted by the CrypTen library. Given a value v, in the literature, [v] often represents secret shares of v. Under the multi-server setting there are three MPC-servers: S₁, S₂ and S₃. Suppose P is the data owner and v is its private value. For illustration purposes, also assume v is a non-negative integer. To secretly share v in Zᵢₙ={0, 1, n−1} where v<n, P performs the following steps:
Randomly choose r₁ and r₂ from Zₙ.
Set r3=v−r₁−r₂ mod n.
Send rᵢ to Sᵢ.
   It is easy to verify that v=r₁+r₂+r₃ mod n and rᵢ is uniformly distributed in Zₙ. In other words, rᵢ does not leak any information on v to Sᵢ, and as long as the MPC servers do not pull their shares together, they will not learn anything about v. In general, [v]={r₁,r₂,r₃}. When we say Sᵢ has a (secret) share [v], it means Sᵢ knows rᵢ. We may use [v]; to represent rᵢ.

When the servers have shares of [u] and [v], they can derive shares of [u+v] (secure addition) and [uv] (secure multiplication) without accessing the actual values u and v. Deriving [u+v] only requires local computations; that is, each server simply adds their own shares together: [u+v]ᵢ=[u]ᵢ+[v]ᵢ. However, deriving [uv] needs a secure multiplication protocol collaboratively performed among the three servers. CrypTen utilizes a variation of additive secret sharing where u is secretly shared between S₁ and S₂, and S₃ is needed for a secure multiplication protocol.

### Security Guarantee of MPC Protocols

The terms “secure” and “privacy-preserving” are interchangeable. A protocol is secure when MPC servers do not learn any information about the private training data as well as the fine-tuned model. The data owners do not learn anything about the other parties' training data. By learning an inference result, it is possible to learn something about the training data. To prevent this inference, DP noise could be securely added to either the fine-tuned model or the inference result.

Under the semi-honest adversary model, a sufficient condition for guaranteeing the security of a protocol is: all computations are performed on secret shares and all intermediate results are secretly shared or randomized. Once the sufficient condition is met, it may be easily shown that the protocol is secure by using the simulation-based proof technique. While using CrypTen to implement a protocol, a sufficient condition is guaranteed. As a consequence, as long as CrypTen itself is secure, so is the protocol.

There are several common ways to fine-tune a language model which can be classified as (1) vanilla fine-tuning (or tuning an entire model), (2) reparameterization-based methods (e.g., LoRA), and (3) specification and addition based methods. Since MPC solutions are computationally expensive, often leading to multiple orders of magnitude overhead, to maximize efficiency a solution disclosed herein may be considered as the addition based method by freezing the base model and adding application-specific layers which are subsequently fine-tuned.

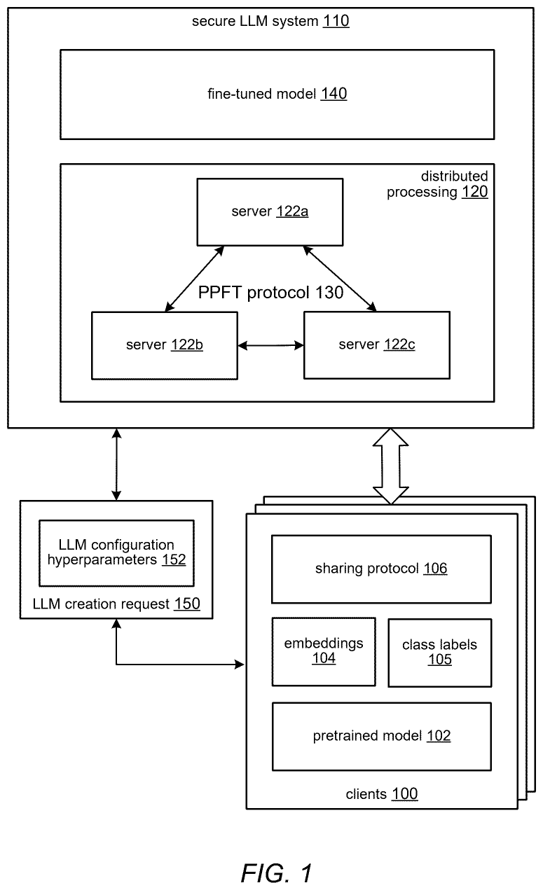

FIG. 1 is a block diagram illustrating a distributed system implementing a secure multiparty protocol for fine-tuning of language models, according to at least one embodiment. A secure LLM system 110 may securely and privately create a fine-tuned model 140 using distributed processing 120 upon request from a client, such as by LLM creation request 150 that may include LLM configuration hyperparameters 152. Secure LLM system 110 may create fine-tuned model 140 according to LLM configuration hyperparameters 152, in at least some embodiments.

Clients 100 may independently implement a common pretrained language model 102 and provide model data, including embeddings 104 and class labels 105, to a secure LLM system 110. In at least one embodiment, clients 100 may provide the model data to secure LLM system 110 using a sharing protocol 106. An end-to-end privacy-preserving fine-tuning (PPFT) protocol 130 may be used by a plurality of server nodes 122a-122c to implement distributed processing 120 for fine-tuning of language models without degradation of training accuracy and while providing security from exposure of sensitive client data, in various embodiments. In at least one embodiment, this secure fine-tuning may result in a fine-tuned model 140 that whose details remain secret with respect to individual clients 100 and to individual servers 122a-122c.

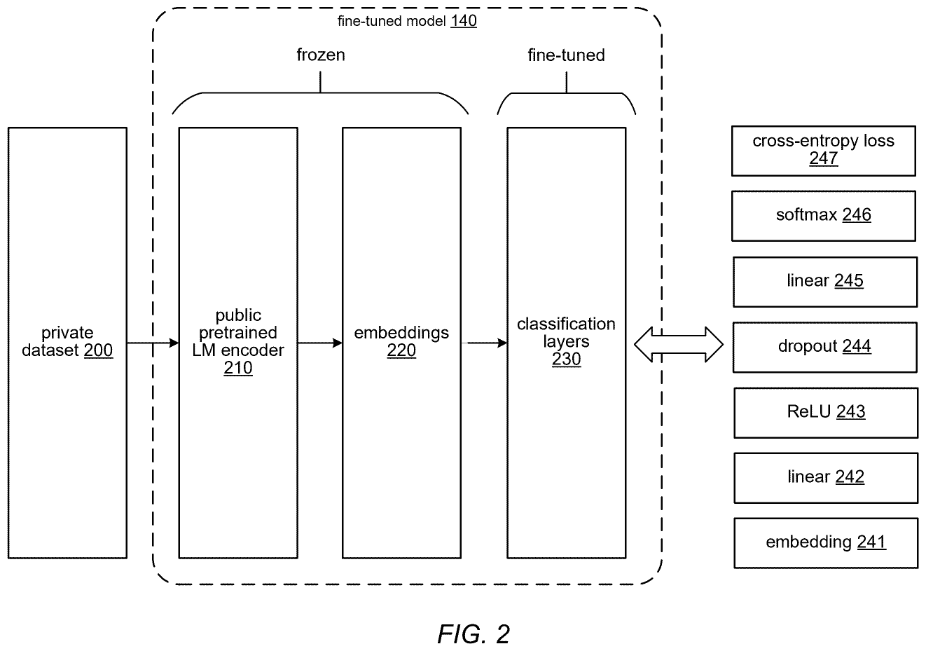

Secure LLM system 110 may use pretrained language model 102 as a basis to create fine-tuned model 140, in at least one embodiment. Fine-tuned model 140 may include a frozen, pretrained portion of a large language model (LLM) and fine-tuned portion, where the frozen portion may be all or part of the pretrained language model 102 and the fine-tuned portion may include portions of the pretrained language model 102 and/or additive layers optimized for fine tuning using PPFT protocol 130. Elements of fine-tuned model 140 are discussed further in FIG. 2 below.

FIG. 2 is a block diagram illustrating a framework for fine-tuning of encoder models using a secure multiparty protocol, according to at least one embodiment. This framework is general and works with any encoder model. In at least one embodiment, private dataset 200 may be provided for fine-tuning of a large language model such as fine-tuned model 140. In at least one embodiment, private dataset 200 may include data from multiple organizations, such as clients 100 of FIG. 1, that must be federated for fine-tuning. The need for such federation may arise from a lack of training data or data diversity. For example, healthcare organizations at different regions may serve a particular group of patients, and specialists may only provide treatment for a limited range of syndromes or diseases. Thus, each organization alone has insufficient amount of fine-tuning data. However, in some case, such as the healthcare example, it may not be possible to aggregate private data due to the sensitive nature of the data. Therefore a PPFT protocol, such as PPFT protocol 130 of FIG. 1, may be employed using a distributed, secure system, such as secure LLM system 110 of FIG. 1, to fine-tune an encoder model such as fine-tuned model 140 while preserving privacy of the data.

In at least one embodiment, to federate the data, portions of the private dataset 200 may be provided to a public, pretrained language model encoder 210 to generate embeddings 220. In at least one embodiment, these embeddings 220 may then be aggregated and used to fine tune an encoder model.

In at least one embodiment, the encoder model may include the public, pretrained LM encoder 210, all or portions of which remain unmodified, or frozen, through the fine-tuning process. An example of LM encoder 210 is pretrained model 102 as shown in FIG. 1. The encoder model may further include one or more classification layers 230 which may be modified during fine-tuning. In at least one embodiment, classification layers 230 and the resultant fine-tuned model 140 may use various layers including embedding 241, linear layers 242 and 245, Rectified Linear Unit (ReLU) activation function 243, dropout layer 244, softmax 246, cross-entropy loss 247 and so on. The layers may be chosen and tuned according to input, configuration parameters or hyperparameters such as LLM configuration hyperparameters 152 of FIG. 1. It should be understood that these are merely examples of component layers and other component layers may be envisioned. Furthermore, while commonly used classification layers are adopted for fine-tuning, these layers may be replaced with those designed for other tasks. Details on these component layers are discussed in further detail below.

### PPFT Protocol

In at least one embodiment, a PPFT protocol may consist of three main stages: (1) embedding generation, (2) secret sharing of the embeddings and class labels, and (3) fine-tuning the head/application layers.

### Fine-Tuning Layers

The overall model architecture is given in FIG. 2. In at least one embodiment, a ReLU activation function may be used for more efficient MPC implementation. Input to the classifier is the CLS embeddings of fine-tuning datasets, represented as matrix E∈R^{b×d} where d represents the embedding size of the pre-trained model and b is the batch size. The embeddings can be extracted from any pre-trained models that work well for a targeted fine-tuning task. In at least one embodiment, evaluation of the classifier may be denoted as Z←F(E); zᵢ←F(eᵢ) for a single sample.

The model architecture given in FIG. 2 shows a classifier consisting of four layers: fully-connected layer 242, ReLU activation layer 243, dropout layer 244, followed by fully-connected layer 245. Following the convention, dropout layer 244 is only applied during training. The weights of the two fully-connected layers are denoted as W¹∈R^{d×d} and W²∈R^{d×k} Here, k denotes the number of output labels. Bias terms are omitted from the protocol description for clarity.

### Cross-Entropy Loss

Softmax 246 and cross-entropy 247 are often used as a loss function during training in classification problems. Given an embedding vector eᵢ∈R^{d} and a one-hot encoding of the target vector yᵢ∈{0,1}^{k} (i.e., y_{i,j}=1 if the target class is j; otherwise y_{i,j}=0, for j∈{l, . . . , k}), the softmax cross-entropy loss is computed as:

$${l}_{CE} ( {𝓏}_{i} , {y}_{i} ) := - {\sum }_{j = 1}^{k} log σ {( {𝓏}_{i} )}_{j}$$

where σ(zᵢ) is the softmax activation function defined as:

$$σ ( 𝓏 i ) j = \frac{{e}^{zij}}{{\sum }_{l = 1}^{k} {e}^{zil}}$$

While the notations consider a computation on a single sample for simplicity, they can be easily generalized for mini-batch samples in which the loss is averaged across all the samples.

### Square Loss

Cross-entropy loss may be a standard loss function for classification tasks. However, square loss may perform comparably or better in many NLP tasks. From MPC aspects, training with the square loss requires less computation and communication costs than that with the cross-entropy loss. Furthermore, square loss provides accuracy better or equal to that of cross-entropy loss.

Two key points of implementing squared loss include (1) the softmax layer 246 is removed when training with the square loss, and (2) loss re-scaling factor 0 is applied when the number of output classes is large (>42) for better model accuracy. Following the previous notations, the re-scaled square loss is defined as:

$${l}_{SL} ( {𝓏}_{i} , {y}_{i} ) = \frac{1}{d} {\sum }_{j = 1}^{k} {( {z}_{ij} - {θ}_{{y}_{ij}} )}^{2}$$

The equation here is slightly different from the original one which has an additional parameter k. When k=1, it corresponds to our listed equation.

### Privacy-Preserving Fine-Tuning

The main steps of our privacy-preserving fine-tuning (PPFR) solution are given in Protocol 1, which can be grouped into the following stages.

Embedding Generation (steps 2-4):

this stage may be performed by each data owner P independently using a pre-trained model L shared among the parties. (tₖ, yₖ) denotes one of the training sample in Dᵢ and yₖ is the class label of tₖ. L(tₖ) produces eₖ, the embedding or feature vector of tₖ. Eᵢ represents the collection of embeddings generated from Dᵢ, and Yᵢ is the collection of the corresponding class labels.

### Secretly Sharing of the Embeddings and Class Labels (Steps 6-11):

Before secretly sharing the embedding, parties need to agree on a secret sharing scheme and its associated parameters, such as share size and modulus. Gen_Shares is a function used by each party to generate secret shares of each party's embeddings. Each embedding has two shares as discussed above, and [Eᵢ]ⱼ indicates the collection of the j-th shares of all embeddings in Eᵢ, for j∈{1, 2}. Each Pᵢ sends [Eᵢ]ⱼ and [Yᵢ]ⱼ to server Sⱼ.

### Share Aggregation (Step 13):

After receiving the shares of embeddings and class labels from all data owners, each Sⱼ collects its shares into a unified collection [E]ⱼ and [Y]ⱼ. Although this is done locally at each server, the embedding ordering in each [E]ⱼ and [Y]ⱼ needs to be the same.

### Fine-Tuning Initialization (Steps 15-17):

These steps are performed by S₃ who serves as an auxiliary server assisting S₁ and S₂ to perform MPC operations, e.g., secure multiplication. The server generates some random matrices W¹ and W² to store the weights of the two dense layers. S₃ also generates secret shares of these matrices and sends the shares to their corresponding servers.

### Private Fine-Tuning of L (Steps 19-33):

All three computing servers collaboratively conduct the following steps per batch within each epoch:
Step 20 securely implements the first dense layer. At the end of this step Z=εW¹.
Steps 21-23 securely implement the ReLU activation function. [Z_{α},β] is the (α,β)-entry of [Z], and Secure_Compare is a secure comparison protocol that returns secret shares of the comparison result c where c=1 means Z_{α,β}>0 and c=0 otherwise. Note that [Z_{α,β}][c] is a secure multiplication operation that allows the protocol to securely keep Z_{α,β} as it is if Z_{α,β}>0. Otherwise, [Z_{α,β}] becomes secret shares of 0.
Steps 24-29 securely implement the dropout layer. R is a b×d-matrix whose entries are randomly generated from range (0,1). U is an indicator matrix where U_{α,β}=0 if R_{α,β}<P and p is the dropout rate; otherwise U_{α,β}=1. Step 27 scales up the non-zero entries of U. Steps 24-27 may be performed by either S₁ or S₂. Suppose S₁ is chosen to perform steps 24-27, then at the end of step 27, S₁ sends U to S₂. The rest of the steps (28, 29) are performed by both Sᵢ and S₂ to set some entries of Z to 0 according to U.
Step 30 securely implements another dense layer which leads to Z=ZW².
Step 31-32 securely compute the loss and update the weights W¹ and W² through the Secure_Backpropagation protocol before training the next batch.

Protocol 1 PPFT (Pi, Di, L), (Sj, ⊥)) → <Sj,[L]j>

| | |
|---|---|
| 1: | // Embedding generation (performed by each Pi) |
| 2: | for each <tₖ,yₖ> ∈ Dᵢ do |
| 3: | eₖ ← L(tₖ) |
| 4: | Eᵢ ← {e₁, ..., e\|Dᵢ\|} and Yᵢ ← {y₁, ..., y\|Dᵢ\|} |
| 5: | // Secret Sharing of Embeddings and class labels (by Pi) |
| 6: | for each <eₖ,yₖ> ∈< Eᵢ,Y_{i>} do |
| 7: | [eₖ]₁,[eₖ]₂ ← Gen_Shares(eₖ) |
| 8: | [yₖ]₁,[yₖ]₂ ← Gen_Shares(yₖ) |
| 9: | [Eᵢ]₁ ← {[e₁]₁, ..., [e_{\|Di\|}]₁) and [Eᵢ]₂ ← {[e₁]₂, ..., [e_{\|Di\|}]₂) |
| 10: | [Yᵢ]₁ ← {[y₁]₁, ..., [y_{\|Di\|}]₁) and [Yᵢ]₂ ← {[y₁]₂, ..., [y_{\|Di\|}]₂) |
| 11: | Send [Eᵢ]₁,[Yᵢ]₁ to S₁ and [Eᵢ]₂,[Yᵢ]₂ to S₂ |
| 12: | // Share aggregation (performed by S₁ and S₂) |
| 13: | [E]ⱼ ← Uᵢ[Eᵢ]ⱼ and [Y]ⱼ ← Uᵢ[Yᵢ]ⱼ, for j ∈ {1,2} |
| 14: | // Fine-tuning initialization (performed by S₃) |
| 15: | Randomly generate W¹ R^{dxd} and W² ∈ R^{dxk} |
| 16: | Generate secret shares: [Z]_{j,} [W¹]ⱼ, [W²]ⱼ for j ∈ {1,2} |
| 17: | Send secret shares: [Z]_{j,} [W¹]ⱼ, [W²]ⱼ to Sⱼ for j ∈ {1,2} |
| 18: | // Private fine-tuning of L (performed by all servers) |
| 19: | for each batch <[ε],[γ]> <[E],[Y]> of size b do |
| 20: | [Z] ← Secure_Matrix_Mult([ε],[W¹]) |
| 21: | for 1 ≤ α ≤ b and 1 ≤ β ≤ d do |
| 22: | [c] ← Secure_Compare([Z_{α,β}],0) |
| 23: | [Z_{α,β}] ← [Z_{α,β}][c] |
| 24: | R ← Gen_Rand_Matrix(0,1) |
| 25: | for 1 ≤ α ≤ b and 1 ≤ β ≤ d do |
| 26: | U_{α,β} ← R_{α,β} < p |
| 27: | U_{α,β} ← U_{α,β} / (1 − p) |
| 28: | for 1 ≤ α ≤ b and 1 ≤ β ≤ d do |
| 29: | [Z_{α,β}] ← [Z_{α,β}] U_{α,β} |
| 30: | [Z] ← Secure_Matrix_Mult([Z],[W²]) |
| 31: | [l] ← Compute_Loss([Z],[γ]) |
| 32: | [W¹],[W²] ← Secure_Backpropagation([W¹],[W²],[l]) |

All secure sub-protocols mentioned in Protocol 1 may be implemented using the tools provided by the CrypTen library. For example, it provides a secure matrix multiplication protocol, a secure comparison protocol, and autograd to implement Secure_Backpropagation.

### Stopping Conditions

The protocol may stop after a fixed number of epochs, e.g., 20 epochs. Alternatively the training loss may be securely compared with a predefined threshold. If the loss is already within the threshold, the training terminates. To implement this stopping condition, the following steps can be added between steps 32 and 33:

| | |
|---|---|
| 32a: | [c] ← SecureCompare([l],δ) |
| 32b: | [c] ← Reveal([c]) |
| 32c: | if c = 1 then |
| 32d: | return [W¹] and [W²] |

The threshold δ is a public information. The comparison result is disclosed by executing the Reveal sub-protocol from which we determine to either terminate or continue the training process.

### ReLU Optimization via Dropout Masks

While Protocol 1 may appear to adopt a simple fine-tuning architecture, training the classifier within an MPC framework is computationally intensive. ReLU operations may be optimized by utilizing dropout masks in the protocol. A key observation is that the dropout layer drops some units where those units are set to zeros. In other words, the ReLU operations applied to those units before the dropout layer were wasted. Because the dropout masks are determined randomly and independent of inputs, pre-process dropout masks may be pre-processed to eliminate unnecessary ReLU operations. By applying this optimization to both forward and backward passes during fine-tuning, a number of ReLU operations from bd to bd(1−p) may be reduced by a reduction rate of p, where p is the dropout rate. Following the same logic, a number of secure dot products required by Secure_Matrix_Mult at step 19 of Protocol 1 may also be reduced.

Some of the mechanisms described herein may be provided as a computer program product, or software, that may include a non-transitory, computer-readable storage medium having stored thereon instructions which may be used to program a computer system 1000 (or other electronic devices) to perform a process according to various embodiments. A computer-readable storage medium may include any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, or other types of medium suitable for storing program instructions. In addition, program instructions may be communicated using optical, acoustical or other form of propagated signal (e.g., carrier waves, infrared signals, digital signals, etc.)

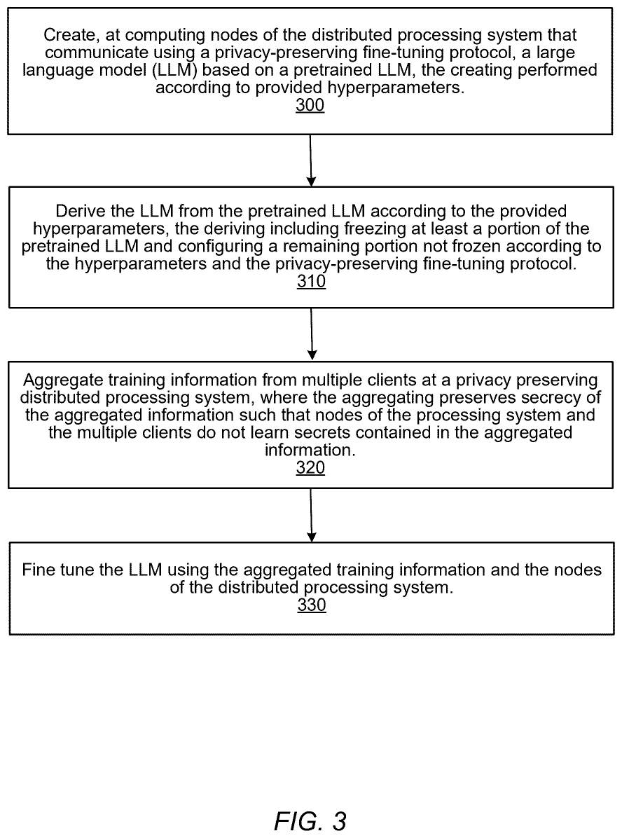

FIG. 3 is a flowchart illustrating creating of an encoder model using a secure multiparty protocol, according to at least one embodiment. The process begins at 300, where, in one embodiment, responsive to a request, such as LLM creation request 152 of FIG. 1, computing nodes of a distributed processing system, such as secure LLM system 110 of FIG. 1, may create a large language model (LLM), such as fine-tuned model 140 of FIG. 1, based on a pretrained LLM, such as pretrained model 102 of FIG. 1, the creating performed according to hyperparameters provided in the request.

As shown in 310, am LLM may be created, or derived, from a pretrained LLM such as pretrained model 102 of FIG. 1. The LLM may be created, in at least one embodiment, using an architecture as described above in FIG. 2. All or portions of the pretrained model may be frozen, and remaining portions, or additional layers such as classification layers 230 of FIG. 2, may be added to be fine tuned. Additional layers may include one or more head layers built on top of the frozen pretrained model layers to transforms output of the pretrained model according to fine-tuned data. In at least one embodiment, portions of the pretrained model chosen to be frozen or fine-tuned, as well as any additive layers built on top of the pretrained model, may be selected according to hyperparameters provided in the creation request. Examples of hyperparameters may include performance constraints for training an inferencing, memory requirements, accuracy of fine-tuning, and so forth. It should be understood that these are merely examples and any number of suitable hyperparameters may be envisioned. By configuring the various layers of the created model according to client input, the created LLM may be optimized to trade off computing and resource requirements related to the PPFT protocol and desired inferencing performance of the created LLM, in various embodiments. Furthermore, various portions of individual layers of the created model may also be optimized according to hyperparameters provided in the creation request. Such optimizations may be used to limit, or balance computational requirements, in particular multiplication operations, that are relatively costly in the PPFT protocol, with desired levels of inferencing performance.

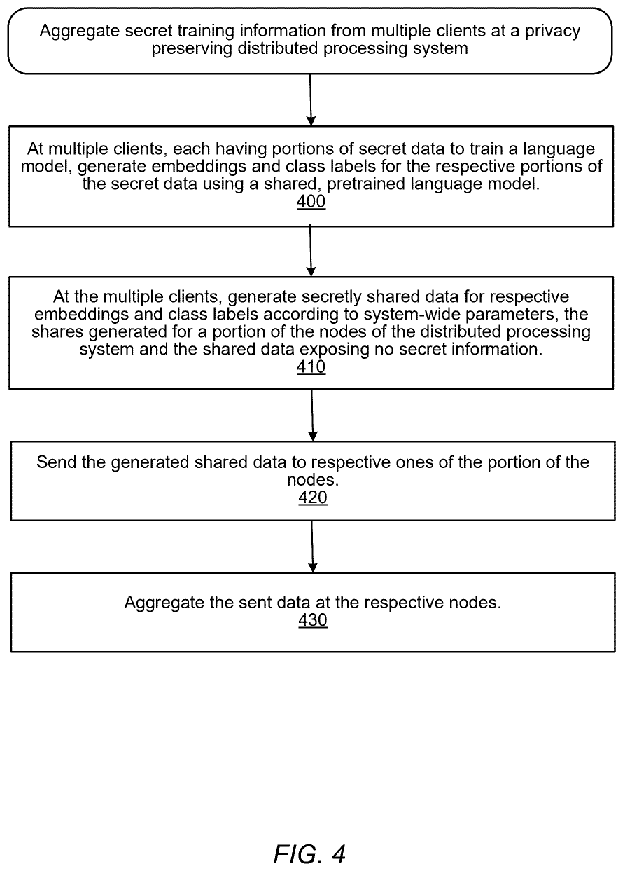

As shown in 320, in at least one embodiment multiple clients, such as clients 100 of FIG. 1, may contribute local secret data sets to generate aggregate training information at a privacy preserving distributed processing system, such as secure LLM system 110 of FIG. 1. This aggregating preserves secrecy of the aggregated information such that nodes of the privacy preserving distributed processing system, such as servers 122a-122c of FIG. 1, and the multiple clients do not learn secrets contained in the aggregated information. This aggregating is discussed in further detail below in FIG. 4.

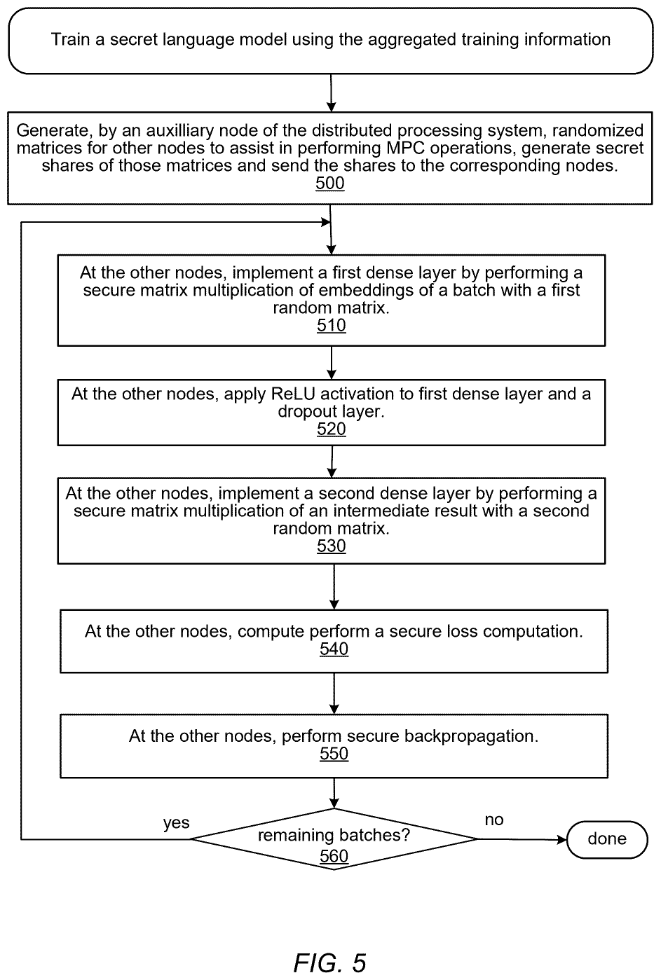

Then, in at least one embodiment as shown in 330, the created LLM may be fine tuned according to the aggregated training information using a privacy preserving fine tuning protocol, such as the PPFT protocol 130 of FIG. 1. In at least one embodiment, fine tuning of the LLM may preserve secrecy such that nodes of the privacy preserving distributed processing system and the multiple clients do not learn secrets contained in the trained model. In some embodiments, once LLM fine tuning is complete, the resultant LLM may be shared with the multiple clients. This fine tuning is discussed in further detail below in FIG. 5.

FIG. 4 is a flowchart illustrating aggregating secret training information for fine-tuning of an encoder model using a secure multiparty protocol, according to at least one embodiment. As shown in 400, multiple clients, such as clients 100, may contribute portions of federated training data to a privacy preserving distributed processing system, such as secure LLM system 110 of FIG. 1. To perform this aggregation, in at least one embodiment, each of the multiple clients may independently use a pretrained model, such as pretrained model 102 of FIG. 1, that is shared among the clients and the privacy preserving distributed processing system, to generate a collection of embeddings, such as embeddings 104 of FIG. 1, and a collection of corresponding class labels, such as class labels 105 of FIG. 1. In at least one embodiment, these embeddings and class labels may be aggregated to generate training information for shared distributed model such as fine-tuned model 140 as shown in FIG. 1.

Then, as shown in 410, in at least one embodiment the clients and distributed processing system may agree on a secret sharing scheme and its associated parameters, such as share size and modulus. Using this secret sharing scheme and associated parameters, the clients may generate secret shares of their individual embeddings. In at least one embodiment, each embedding may have a generated secret share for each processing server of the distributed processing system. By sharing the data using secret sharing scheme, no shared exposes secret information of any of the clients to other clients or to any nodes if the distributed processing system, in at least one embodiment.

Then, as shown in 420, in at least one embodiment the various clients send the generated share data to respective processing nodes of the distributed processing system where they are aggregated by those respective nodes, as shown in 430.

FIG. 5 is a flowchart illustrating training of an encoder model using a secure multiparty protocol, according to at least one embodiment. As shown in 500, in at least one embodiment a privacy preserving distributed processing system, such as secure LLM system 110 of FIG. 1, may include three processing nodes, such as servers 122a, 112b and 122c as shown in FIG. 1, where two of the nodes serve as primary computing nodes and a third serves as an auxiliary node that assist the primary nodes in performing MPC operations such as secure multiplication. To assist the primary nodes, the auxiliary node may generate randomized matrices to store weights of two dense layers, then generate secret shares of those matrices and send the secret shares to corresponding primary nodes, in at least one embodiment.

After completion of initialization of randomized matrices, a number of training batches may be performed, in at least one embodiment. Batch sizes may be chosen according to specific PPFT protocol requirements as well as provided model hyperparameters such as LLM configuration hyperparameters 152 of FIG. 1, in at least one embodiment. As shown in 510, the primary nodes may each implement a first dense layer by performing a secure matrix multiplication of an embeddings matrix and a first randomized matrix.

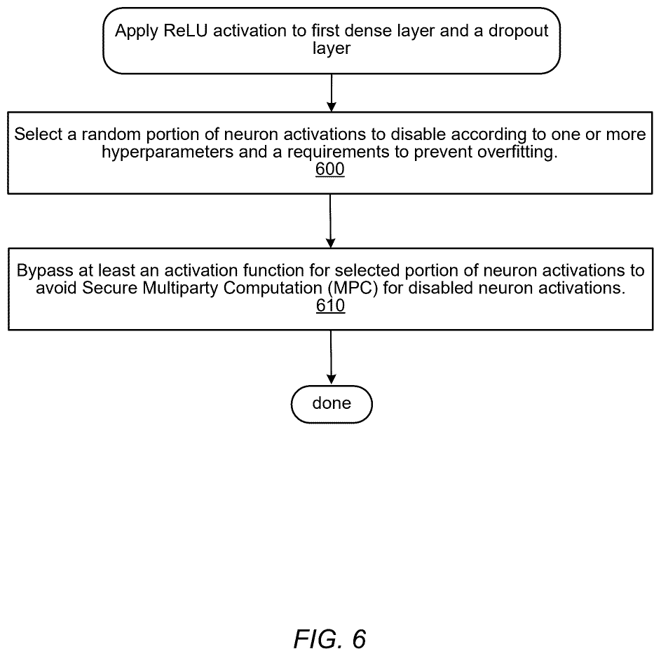

Then, as shown in 520, a ReLU activation function may be securely applied at each primary node to the first dense layer, in at least one embodiment and a dropout layer implemented. In at least one embodiment, the order of the operations may be reverses such that the dropout layer may enable bypassing of a portion of ReLU activation functions. This step is discussed in further detail in FIG. 6 below. Implementation of activation functions and dropout layers may be tuned according to specific PPFT protocol requirements as well as provided model hyperparameters such as LLM configuration hyperparameters 152 of FIG. 1, in at least one embodiment.

Then, as shown in 530, the primary nodes may each implement a second dense layer by performing a secure matrix multiplication of a result matrix resulting from step 520 and a second randomized matrix.

Then, as shown in 540, the primary nodes may each perform a secure loss computation in at least one embodiment, then perform a secure back propagation operation according to the computed loss at each of the primary nodes. Implementation of secure loss computations may be tuned according to specific PPFT protocol requirements as well as provided model hyperparameters such as LLM configuration hyperparameters 152 of FIG. 1, in at least one embodiment. For example, a square loss function may be used instead of traditional loss functions such as Mean Squared Error (MS) or Cross-Entropy Loss functions in order to improve computational efficiency using a PPFT protocol. It should be understand that this is merely one example and other optimized loss functions may be employed in various embodiments.

Then, if training batches remain, as indicated by a positive exit from 560, the process may return to 510. If no training batches remain, as indicated by a negative exit from 560, then the process is complete.

FIG. 6 is a flowchart illustrating an alternative activation function and dropout layer for training of an encoder model using a secure multiparty protocol, according to at least one embodiment. In some embodiments, activation function operations may be optimized by utilizing dropout masks in the PPFT protocol. A dropout layer may drops some neuron activations where those units are set to zeros. In other words, the activation operations applied to those units before the dropout layer may be wasted. Because the dropout masks are determined randomly and independent of inputs, pre-process dropout masks may be pre-processed prior to layers such as activation layers to eliminate unnecessary activation operations. By applying this optimization to both forward and backward passes during fine-tuning, a number of activation operations may be reduced according to hyperparameters for a model. Following the same logic, a number of secure dot products may also be reduced.

As shown in 600, in at least one embodiment a random portion of neuron activations may be selected for disabling. A number, or percentage, of total neuron activations may be chosen according to satisfy potential overfitting prevention as well as computational requirements determined according to model hyperparameters, such as LLM configuration hyperparameters 152 of FIG. 1. Then, as shown in 610, activation functions for the selected portion of neuron activations may be bypassed, reducing computations in a PPFT protocol. Implementation, or choice, of activation functions for non-disabled neuron activations may be tuned according to specific PPFT protocol requirements as well as provided model hyperparameters such as LLM configuration hyperparameters 152 of FIG. 1, in at least one embodiment. For example, a ReLU activation function, such as described above, may be used for more efficient MPC implementation, in at least one embodiment. It should be understood that this is merely one example of an activation function chosen to optimize MPC implementation and that other activation functions may be envisioned. For a remaining portion of neuron activations, a configured activation function may be applied. The process is then complete.

Some of the mechanisms described herein may be provided as a computer program product, or software, that may include a non-transitory, computer-readable storage medium having stored thereon instructions which may be used to program a computer system 2000 (or other electronic devices) to perform a process according to various embodiments. A computer-readable storage medium may include any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, or other types of medium suitable for storing program instructions. In addition, program instructions may be communicated using optical, acoustical or other form of propagated signal (e.g., carrier waves, infrared signals, digital signals, etc.)

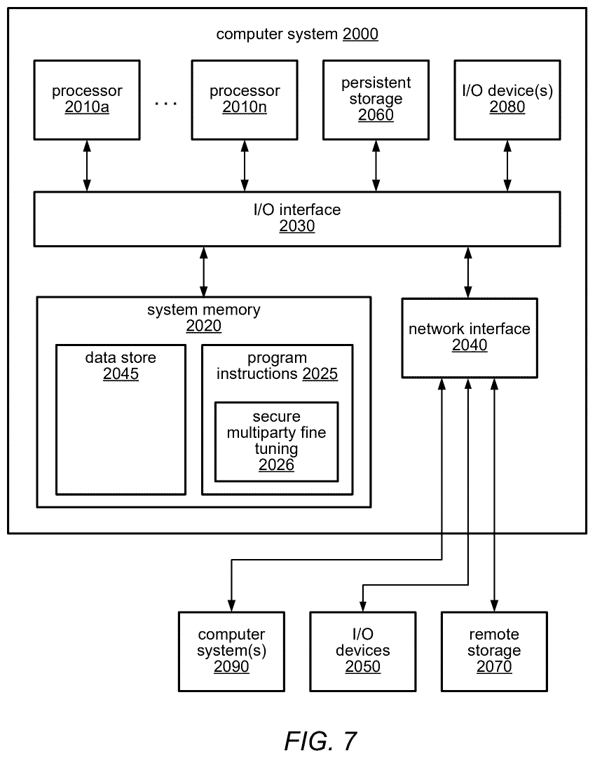

Any of various computer systems may be configured to implement processes associated with a technique for multi-region, multi-primary data store replication as discussed with regard to the various figures above. FIG. 7 is a block diagram illustrating one embodiment of a computer system suitable for implementing some or all of the techniques and systems described herein. In some cases, a host computer system may host multiple virtual instances that implement the servers, request routers, storage services, control systems or client(s). However, the techniques described herein may be executed in any suitable computer environment (e.g., a cloud computing environment, as a network-based service, in an enterprise environment, etc.).

Various ones of the illustrated embodiments may include one or more computer systems 2000 such as that illustrated in FIG. 7 or one or more components of the computer system 2000 that function in a same or similar way as described for the computer system 2000.

In the illustrated embodiment, computer system 2000 includes one or more processors 2010 coupled to a system memory 2020 via an input/output (I/O) interface 2030. Computer system 2000 further includes a network interface 2040 coupled to I/O interface 2030. In some embodiments, computer system 2000 may be illustrative of servers implementing enterprise logic or downloadable applications, while in other embodiments servers may include more, fewer, or different elements than computer system 2000.

Computer system 2000 includes one or more processors 2010 (any of which may include multiple cores, which may be single or multi-threaded) coupled to a system memory 2020 via an input/output (I/O) interface 2030. Computer system 2000 further includes a network interface 2040 coupled to I/O interface 2030. In various embodiments, computer system 2000 may be a uniprocessor system including one processor 2010, or a multiprocessor system including several processors 2010 (e.g., two, four, eight, or another suitable number). Processors 2010 may be any suitable processors capable of executing instructions. For example, in various embodiments, processors 2010 may be general-purpose or embedded processors implementing any of a variety of instruction set architectures (ISAs), such as the x86, PowerPC, SPARC, or MIPS ISAs, or any other suitable ISA. In multiprocessor systems, each of processors 2010 may commonly, but not necessarily, implement the same ISA. The computer system 2000 also includes one or more network communication devices (e.g., network interface 2040) for communicating with other systems and/or components over a communications network (e.g. Internet, LAN, etc.). For example, a client application executing on system 2000 may use network interface 2040 to communicate with a server application executing on a single server or on a cluster of servers that implement one or more of the components of the embodiments described herein. In another example, an instance of a server application executing on computer system 2000 may use network interface 2040 to communicate with other instances of the server application (or another server application) that may be implemented on other computer systems (e.g., computer systems 2090).

System memory 2020 may store instructions and data accessible by processor 2010. In various embodiments, system memory 2020 may be implemented using any suitable memory technology, such as static random-access memory (SRAM), synchronous dynamic RAM (SDRAM), non-volatile/Flash-type memory, or any other type of memory. In the illustrated embodiment, program instructions and data implementing desired functions, such as those methods and techniques as described above for secure multiparty fine-tuning of language models as indicated at 2026, for the downloadable software or provider network are shown stored within system memory 2020 as program instructions 2025. In some embodiments, system memory 2020 may include data store 2045 which may be configured as described herein.

In some embodiments, system memory 2020 may be one embodiment of a computer-accessible medium that stores program instructions and data as described above. However, in other embodiments, program instructions and/or data may be received, sent or stored upon different types of computer-accessible media. Generally speaking, a computer-accessible medium may include computer-readable storage media or memory media such as magnetic or optical media, e.g., disk or DVD/CD-ROM coupled to computer system 2000 via I/O interface 2030. A computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. Further, a computer-accessible medium may include transmission media or signals such as electrical, electromagnetic, or digital signals, conveyed via a communication medium such as a network and/or a wireless link, such as may be implemented via network interface 2040.

In one embodiment, I/O interface 2030 may coordinate I/O traffic between processor 2010, system memory 2020 and any peripheral devices in the system, including through network interface 2040 or other peripheral interfaces. In some embodiments, I/O interface 2030 may perform any necessary protocol, timing or other data transformations to convert data signals from one component (e.g., system memory 2020) into a format suitable for use by another component (e.g., processor 2010). In some embodiments, I/O interface 2030 may include support for devices attached through various types of peripheral buses, such as a variant of the Peripheral Component Interconnect (PCI) bus standard or the Universal Serial Bus (USB) standard, for example. In some embodiments, the function of I/O interface 2030 may be split into two or more separate components, such as a north bridge and a south bridge, for example. Also, in some embodiments, some or all of the functionality of I/O interface 2030, such as an interface to system memory 2020, may be incorporated directly into processor 2010.

Network interface 2040 may allow data to be exchanged between computer system 2000 and other devices attached to a network, such as between a client device and other computer systems, or among hosts, for example. In particular, network interface 2040 may allow communication between computer system 800 and/or various other device 2060 (e.g., I/O devices). Other devices 2060 may include scanning devices, display devices, input devices and/or other communication devices, as described herein. Network interface 2040 may commonly support one or more wireless networking protocols (e.g., Wi-Fi/IEEE 802.7, or another wireless networking standard). However, in various embodiments, network interface 2040 may support communication via any suitable wired or wireless general data networks, such as other types of Ethernet networks, for example. Additionally, network interface 2040 may support communication via telecommunications/telephony networks such as analog voice networks or digital fiber communications networks, via storage area networks such as Fibre Channel SANs, or via any other suitable type of network and/or protocol.

In some embodiments, I/O devices may be relatively simple or “thin” client devices. For example, I/O devices may be implemented as dumb terminals with display, data entry and communications capabilities, but otherwise little computational functionality. However, in some embodiments, I/O devices may be computer systems implemented similarly to computer system 2000, including one or more processors 2010 and various other devices (though in some embodiments, a computer system 2000 implementing an I/O device 2050 may have somewhat different devices, or different classes of devices).

In various embodiments, I/O devices (e.g., scanners or display devices and other communication devices) may include, but are not limited to, one or more of: handheld devices, devices worn by or attached to a person, and devices integrated into or mounted on any mobile or fixed equipment, according to various embodiments. I/O devices may further include, but are not limited to, one or more of: personal computer systems, desktop computers, rack-mounted computers, laptop or notebook computers, workstations, network computers, “dumb” terminals (i.e., computer terminals with little or no integrated processing ability), Personal Digital Assistants (PDAs), mobile phones, or other handheld devices, proprietary devices, printers, or any other devices suitable to communicate with the computer system 2000. In general, an I/O device (e.g., cursor control device, keyboard, or display(s) may be any device that can communicate with elements of computing system 2000.

The various methods as illustrated in the figures and described herein represent illustrative embodiments of methods. The methods may be implemented manually, in software, in hardware, or in a combination thereof. The order of any method may be changed, and various elements may be added, reordered, combined, omitted, modified, etc. For example, in one embodiment, the methods may be implemented by a computer system that includes a processor executing program instructions stored on a computer-readable storage medium coupled to the processor. The program instructions may be configured to implement the functionality described herein.

Various modifications and changes may be made as would be obvious to a person skilled in the art having the benefit of this disclosure. It is intended to embrace all such modifications and changes and, accordingly, the above description to be regarded in an illustrative rather than a restrictive sense.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

Embodiments of decentralized application development and deployment as described herein may be executed on one or more computer systems, which may interact with various other devices. FIG. 7 is a block diagram illustrating an example computer system, according to various embodiments. For example, computer system 2000 may be configured to implement nodes of a compute cluster, a distributed key value data store, and/or a client, in different embodiments. Computer system 2000 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of compute node, computing node, or computing device.

In the illustrated embodiment, computer system 2000 also includes one or more persistent storage devices 2060 and/or one or more I/O devices 2080. In various embodiments, persistent storage devices 2060 may correspond to disk drives, tape drives, solid state memory, other mass storage devices, or any other persistent storage device. Computer system 2000 (or a distributed application or operating system operating thereon) may store instructions and/or data in persistent storage devices 2060, as desired, and may retrieve the stored instruction and/or data as needed. For example, in some embodiments, computer system 2000 may be a storage host, and persistent storage 2060 may include the SSDs attached to that server node.

In some embodiments, program instructions 2025 may include instructions executable to implement an operating system (not shown), which may be any of various operating systems, such as UNIX, LINUX, Solaris™, MacOS™, Windows™, etc. Any or all of program instructions 2025 may be provided as a computer program product, or software, that may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computer system 2000 via I/O interface 2030. A non-transitory computer-readable storage medium may also include any volatile or non-volatile media such as RAM (e.g. SDRAM, DDR SDRAM, RDRAM, SRAM, etc.), ROM, etc., that may be included in some embodiments of computer system 2000 as system memory 2020 or another type of memory. In other embodiments, program instructions may be communicated using optical, acoustical or other form of propagated signal (e.g., carrier waves, infrared signals, digital signals, etc.) conveyed via a communication medium such as a network and/or a wireless link, such as may be implemented via network interface 2040.

It is noted that any of the distributed system embodiments described herein, or any of their components, may be implemented as one or more network-based services. For example, a compute cluster within a computing service may present computing services and/or other types of services that employ the distributed computing systems described herein to clients as network-based services. In some embodiments, a network-based service may be implemented by a software and/or hardware system designed to support interoperable machine-to-machine interaction over a network. A network-based service may have an interface described in a machine-processable format, such as the Web Services Description Language (WSDL). Other systems may interact with the network-based service in a manner prescribed by the description of the network-based service's interface. For example, the network-based service may define various operations that other systems may invoke and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the network-based service, using an Internet-based application layer transfer protocol such as Hypertext Transfer Protocol (HTTP).

In some embodiments, network-based services may be implemented using Representational State Transfer (“RESTful”) techniques rather than message-based techniques. For example, a network-based service implemented according to a RESTful technique may be invoked through parameters included within an HTTP method such as PUT, GET, or DELETE, rather than encapsulated within a SOAP message.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

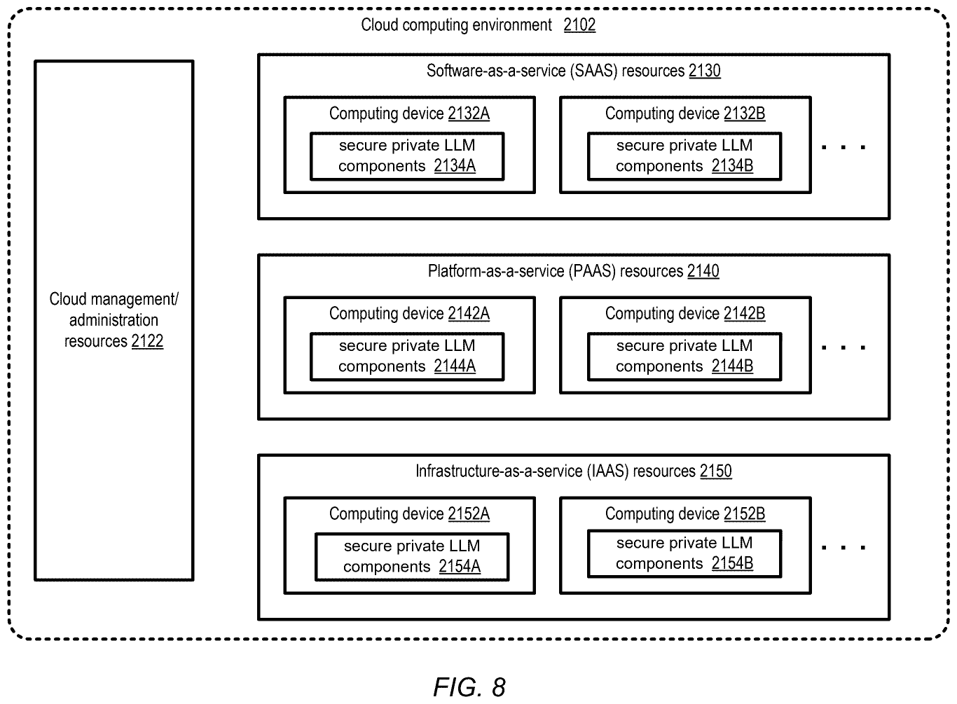

FIG. 8 illustrates an example cloud computing environment whose resources may be employed to implement a topic modeling system that includes stability monitoring, according to at least some embodiments. As shown, cloud computing environment 2102 may include cloud management/administration resources 2122, software-as-a-service (SAAS) resources 2130, platform-as-a-service (PAAS) resources 2140 and/or infrastructure-as-a-service (IAAS) resources 2150. Individual ones of these subcomponents of the cloud computing environment 2102 may include a plurality of computing devices (e.g., devices similar to device 2000 shown in FIG. 5) distributed among one or more data centers in the depicted embodiment, such as devices 2132A, 2132B, 2142A, 2142B, 2152A, 2152B and the like. A number of different types of network-accessible services, such as topic modeling services, database services, customer-relationship management services, machine learning services and the like may be implemented using the resources of the cloud computing environment in various embodiments.

In the depicted embodiment, clients or customers of the cloud computing environment 2102 may choose the mode in which they wish to utilize one or more of the network-accessible services offered. For example, in the IAAS mode, in some embodiments the cloud computing environment may manage virtualization, servers, storage and networking on behalf of the clients, but the clients may have to manage operating systems, middleware, data, runtimes, and applications. If, for example, a client wishes to use IAAS resources 2150 for secure private LLM generation, the clients may identify one or more virtual machines implemented using computing devices 2152 (e.g., 2152A or 2152B) as the platforms on which the secure private LLM components 2154 (e.g., 2154A, 2154B, etc.) are to be run, download the tools, and issue commands to perform topic modeling via programmatic interfaces provided by the cloud computing environment.

In the PAAS mode, clients may be responsible for managing a smaller subset of the software/hardware stack in various embodiments: e.g., while the clients may still be responsible for application and data management, the cloud environment may manage virtualization, servers, storage, network, operating systems as well as middleware. secure private LLM components 2144 (e.g., 2144A, 2144B, etc.) may be deployed to, and run at, PAAS resources (e.g., 2142A, 2142B etc.) as applications managed by various clients in different embodiments.

In the SAAS mode, the cloud computing environment may offer topic modeling as a pre-packaged service, managing even more of the software/hardware stack in various embodiments—e.g., clients may not even have to explicitly manage applications or data. Instead, for example, with respect to secure private LLM functionality of the kind discussed above, clients may simply submit (e.g., via programmatic interfaces) LLM creation requests such as LLM creation request 150 of FIG. 1 and the SAAS resources may utilize secure private LLM components 2134 (e.g., 2134A, 2134B, etc.) pre-installed on computing devices 2132 (e.g., 2132A, 2143B etc.) to generate, store, and display topic models as desired.

The administration resources 2122 may perform resource management-related operations (such as provisioning, network connectivity, ensuring fault tolerance and high availability, and the like) for all the different modes of cloud computing that may be supported in various embodiments. Clients may interact with various portions of the cloud computing environment using a variety of programmatic interfaces in different embodiments, such as a set of APIs (application programming interfaces), web-based consoles, command-line tools, graphical user interfaces and the like. Note that other modes of providing services (including topic modeling services) may be supported in at least some embodiments, such as hybrid public-private clouds and the like.

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed:

1. A system, comprising:
a plurality of computing nodes individually comprising at least one processor and memory, the plurality of computing nodes configured to communicate using a privacy-preserving fine-tuning protocol to create a fine-tuned large language model (LLM) according to one or more hyperparameters, wherein to create the fine-tuned LLM the plurality of computing nodes are configured to:
derive the fine-tuned LLM from a pretrained LLM according to the one or more hyperparameters, wherein to derive the fine-tuned LLM the plurality of computing nodes are configured to:
freeze at least a portion of the pretrained LLM; and
configure a remaining portion of the fine-tuned LLM according to the one or more hyperparameters and the privacy-preserving fine-tuning protocol;
receive respective training information from individual clients of a plurality of clients, wherein secrecy of the respective training information is preserved with respect to individual nodes of the plurality of computing nodes; and
fine tune the remaining portion of the fine-tuned LLM according to the respective secret training information and the privacy-preserving fine-tuning protocol.

2. The system of claim 1, wherein the privacy-preserving fine-tuning protocol comprises computations performed according to a secure multiparty computation protocol.

3. The system of claim 1, wherein the secret language model is trained according to a square loss function.

4. The system of claim 1, wherein the respective training information from the individual clients individually comprises embeddings and class labels generated by the respective individual clients according to secret client data and the pretrained LLM.

5. The system of claim 1, wherein the fine-tuned LLM comprises the pretrained LLM and at least one additive head layer, wherein the freezing comprises freezing the pretrained LLM, and wherein the remaining portion of the fine-tuned LLM comprises the at least one additive head layer.

6. The system of claim 1, wherein to configure the remaining portion of the fine-tuned LLM the plurality of computing nodes are configured to:
determine a number of layers for the remaining portion of the fine-tuned LLM according to the one or more hyperparameters;
configure a fine-tuning batch size according to the one or more hyperparameters and the privacy-preserving fine-tuning protocol; and
configure the at least one additive head layer according to the one or more hyperparameters and the privacy-preserving fine-tuning protocol.

7. The system of claim 6, wherein the at least one additive head layer comprises:
a rectified linear unit (ReLU) activation function; and
a dropout mask that selective disables one or more portions of the ReLU activation function according to the one or more hyperparameters.

8. A method comprising:
creating, by a plurality of computing nodes communicating using a privacy-preserving fine-tuning protocol, a fine-tuned large language model (LLM) according to one or more hyperparameters, the creating comprising:
deriving the fine-tuned LLM from a pretrained LLM according to the one or more hyperparameters, the deriving comprising:
freezing at least a portion of the pretrained LLM; and
configuring a remaining portion of the fine-tuned LLM according to the one or more hyperparameters and the privacy-preserving fine-tuning protocol;
receiving respective training information from individual clients of a plurality of clients, wherein secrecy of the respective training information is preserved with respect to individual nodes of the plurality of computing nodes; and
fine tuning the remaining portion of the fine-tuned LLM according to the respective secret training information and the privacy-preserving fine-tuning protocol.

9. The method of claim 8, wherein the privacy-preserving fine-tuning protocol comprises computations performed according to a secure multiparty computation protocol.

10. The method of claim 8, wherein the fine-tuned LLM is fine tuned according to a square loss function.

11. The method of claim 8, wherein the respective training information from the individual clients individually comprises embeddings and class labels generated by the respective individual clients according to secret client data and the pretrained LLM.

12. The method of claim 8, wherein the fine-tuned LLM comprises the pretrained LLM and at least one additive head layer, wherein the freezing comprises freezing the pretrained LLM, and wherein the remaining portion of the fine-tuned LLM comprises the at least one additive head layer.

13. The method of claim 12, wherein configuring the remaining portion of the fine-tuned LLM comprises one or more of:
determining a number of layers for the remaining portion of the fine-tuned LLM according to the one or more hyperparameters;
configuring a fine-tuning batch size according to the one or more hyperparameters and the privacy-preserving fine-tuning protocol; and
configuring the at least one additive head layer according to the one or more hyperparameters and the privacy-preserving fine-tuning protocol.

14. The method of claim 12, wherein the at least one additive head layer comprises:
a rectified linear unit (ReLU) activation function; and
a dropout mask that selective disables one or more portions of the ReLU activation function according to the one or more hyperparameters.

15. One or more non-transitory, computer-readable storage media, storing program instructions that when executed on or across one or more processors cause the one or more processors to perform:
implementing a node of a plurality of computing nodes communicating according to privacy-preserving fine-tuning protocol to create a fine-tuned large language model (LLM) according to one or more hyperparameters, the creating comprising:
deriving the fine-tuned LLM from a pretrained LLM according to the one or more hyperparameters, the deriving comprising:
freezing at least a portion of the pretrained LLM; and
configuring a remaining portion of the fine-tuned LLM according to the one or more hyperparameters and the privacy-preserving fine-tuning protocol;
receiving respective training information from individual clients of a plurality of clients, wherein secrecy of the respective training information is preserved with respect to individual nodes of the plurality of computing nodes; and
fine tuning the remaining portion of the fine-tuned LLM according to the respective secret training information and the privacy-preserving fine-tuning protocol.

16. The one or more non-transitory, computer-readable storage media of claim 15, wherein the privacy-preserving fine-tuning protocol comprises computations performed according to a secure multiparty computation protocol.

17. The one or more non-transitory, computer-readable storage media of claim 15, wherein the fine-tuned LLM is fine tuned according to a square loss function.

18. The one or more non-transitory, computer-readable storage media of claim 15, wherein the respective training information from the individual clients individually comprises embeddings and class labels generated by the respective individual clients according to secret client data and the pretrained LLM.

19. The one or more non-transitory, computer-readable storage media of claim 15, wherein the fine-tuned LLM comprises the pretrained LLM and at least one additive head layer, wherein the freezing comprises freezing the pretrained LLM, and wherein the remaining portion of the fine-tuned LLM comprises the at least one additive head layer.

20. The one or more non-transitory, computer-readable storage media of claim 19, wherein configuring the remaining portion of the fine-tuned LLM comprises one or more of:
determining a number of layers for the remaining portion of the fine-tuned LLM according to the one or more hyperparameters;
configuring a fine-tuning batch size according to the one or more hyperparameters and the privacy-preserving fine-tuning protocol; and
configuring the at least one additive head layer according to the one or more hyperparameters and the privacy-preserving fine-tuning protocol.
